(19) United States
(12) Patent Application Publication
(10) Pub. No.: US 2015/0086949 A1
(43) Pub. Date: Mar. 26, 2015

(54) USING USER MOOD AND CONTEXT TO ADVISE USER

(71) Applicants: Hong Li, El Dorado Hills, CA (US); Joshua Boelter, Portland, OR (US); Sharad Garg, Portland, OR (US); Mark Yarvis, Portland, OR (US)

(72) Inventors: Hong Li, El Dorado Hills, CA (US); Joshua Boelter, Portland, OR (US); Sharad Garg, Portland, OR (US); Mark Yarvis, Portland, OR (US)

(21) Appl. No.: 14/126,563

(22) PCT Filed: Sep. 20, 2013
(86) PCT No.: PCT/US2013/060902

§ 371 Date: Dec. 16, 2013

(51) Int. Cl. G09B 5/00

(52) U.S. Cl. CPC G09B 5/00
USPC 434/236

(57) ABSTRACT

Various systems and methods for using a user's mood and context to advise a user are described herein. Data may be received at a mobile device, the mobile device associated with the user. A mood of the user is determined based on the data. An event involving the user is identified and advice is provided to the user regarding the event, the advice based on the received data, the mood, and the event.

### TECHNICAL FIELD

Embodiments described herein generally relate to data collection and in particular, to a system and method for using a user's mood and context to advise the user.

### BACKGROUND

Often, the decisions people make are affected by personal contextual factors, such as stress, sleepiness, or mood. When decisions are made under poorly understood emotional or physiological conditions, the decisions may be unsafe or unwise.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a system for using a user's mood and context to advise the user, according to an embodiment;

FIG. 2 is a flowchart illustrating a method of detecting a user's mood and using the mood to advise the user, according to an embodiment;

FIG. 3 is a flowchart illustrating a method of using a user's mood and context to advise the user, according to an embodiment; and

FIG. 4 is a block diagram illustrating an example machine upon which any one or more of the techniques (e.g., methodologies) discussed herein may perform, according to an example embodiment.

### DETAILED DESCRIPTION

The integration of electronics into everyday life is increasing from year to year. Many people choose to carry personal electronics, such as cellular phones, personal digital assistants, tablet computers, or laptops. Personal electronics may be adapted to sense physiological, environmental, and other information to build and maintain a personal context that indicates a person's mood (e.g., emotional state). With such information, a personal electronic device may be used to inform a user of their mood. In addition, the personal electronic device may advise the user with respect to a decision or event, in view of the sensed mood.

The present disclosure describes a system for using information about a person's mood in combination with other user context (such as biological, health, location, etc.) to make intelligent decisions, suggestions, take actions, and so on. The system may determine activities that the user is currently involved in or is scheduled to be involved in. Activities such as meetings, speeches, drafting contracts, or other important or significant events such as travel, visit to hospital to see a friend or a family member, etc., may be tracked, ascertained, or inferred from the user's environment, activities, or related data. Once determined, the system may provide advice to the user regarding the activities that the user is currently or scheduled to be involved in. In addition, the system may advise or inform others in the user's social circles, such as friends, family, or professional contacts, about the user's current mood condition. The amount and kind of advice provided by the system may be controlled or configured by the user. Similarly, the amount or kind of sharing of the user's mood may be controlled or configured by the user. The sensed information about a user's mood may be correlated and used to assist the user in making intelligent decisions on corresponding actions.

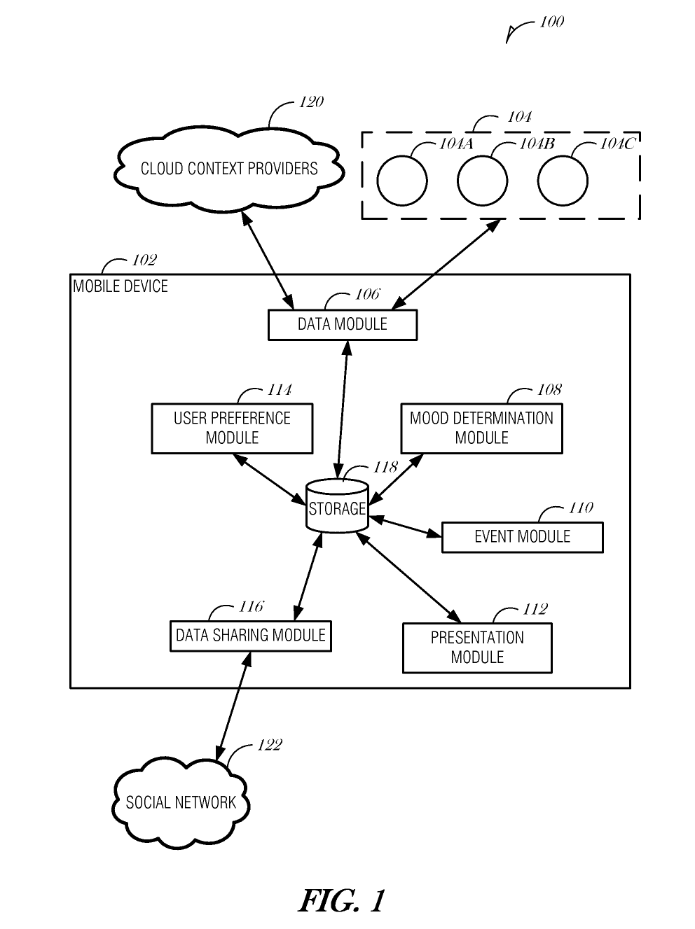

FIG. 1 is a schematic drawing illustrating a system 100 for using a user's mood and context to advise the user, according to an embodiment. The system 100 may be a computer system and may be worn or carried by a person. Portions of the system 100 may be incorporated into a device, such as a wearable device (smart watch, smart glasses, etc.), smartphone, laptop, or tablet computer. In addition, the system 100 may be integrated with sensors or other systems, such as physiological monitors, navigation systems, or environmental systems.

Physiological monitors may include heart rate monitors, blood pressure monitors, skin temperature monitors, or the like. Navigation systems may include global positioning systems, indoor location systems, mapping systems, or traffic routing systems. Environmental systems may include environmental thermometers, microphones, solar radiometer, weather services, or the like.

A navigation or location based system may be used to determine a location of the user or of a mobile device 102 in use by the user. Navigation information may provide an insight into the user's context, such as traffic conditions that the user is experiencing, road construction, time in the vehicle, etc. Location information or other navigation information may be timestamped. A timestamp may be a sequence of characters denoting the date and/or time at which a certain event occurred.

External environmental information may be any information related to events or objects that occur or exist around the user or the mobile device 102. Sensors may be used to determine or obtain weather-related information, humidity, temperature, ambient noise, and the like.

In the system 100, a mobile device 102 receives data from one or more sensors 104A, 104B, and 104C (collectively 104). The sensors 104 may include physiological monitors, navigation systems, environmental systems, such as described above, or other types of sensors, detectors, or monitors used to obtain data from or about the user or the user's environment. The sensors 104 may be incorporated into the mobile device 102 (e.g., a camera integrated into a smartphone), or may be external and separate from the mobile device 102.

The mobile device 102 includes a data module 106, a mood determination module 108, an event module 110, a presentation module 112, a user preference module 114, and a data sharing module 116. The mobile device 102 also includes a storage device 118, which may be of any memory type, such as random access memory (RAM), magnetic disk storage media, optical storage media, flash-memory devices, or other types of storage devices or media. The storage device 118 may be of various form factors, such as a secure digital (SD™) card, a CompactFlash® (CF) card, or a universal serial bus (USB) drive.

In an embodiment, the data module 106 is arranged to receive data at the device 102. The data module 106 may receive data from various sources, such as the sensors 104. In addition, the data module 106 may receive information from a cloud context provider 120. A cloud context provider 120 is a service that provides or maintains information for the user, which may be used to determine a context of the user. For example, a cloud context provider 120 may maintain an appointment schedule for the user (e.g., an online calendar). Using the appointment schedule, the mobile device 102 may be able to ascertain or infer a location or other contextual information that may affect the user's mood or emotional state. As another example, the data module 106 may be arranged to receive data from a device worn by the user. Worn devices may be physiological monitors, such as a blood pressure monitor incorporated into a wrist watch or a chest strap. The data module 106 may also coordinate data acquisition between cloud context providers 120 and sensors 104. For example, the data module 106 may query a cloud weather service to provide weather context related to the user's current location sensed by a GPS sensor.

The mood determination module 108 is arranged to determine a mood of the user based on the collected data. The mood determination module 108 may use various statistical mechanisms to correlate a user's context, physiological state, and other inputs to determine a user's mood.

In an embodiment, the data received by the data module 106 includes physiological data. In such an embodiment, to determine the mood of the user, the mood determination module 108 is arranged to analyze the physiological data according to a model and based on the analysis, classify the mood.

In an embodiment, the data received by the data module 106 includes location data. Thus, to determine the mood of the user, the mood determination module 108 may be arranged to identify a location based on the location data and determine a correlation between the location and the mood to classify the mood.

The event module 110 is arranged to identify an event involving the user. Events include, but are not limited to events on a schedule (e.g., calendar), events that are detected (e.g., based on monitoring phone calls, text messages, or other contemporaneous messages to determine a meeting, errand, appointment, or other event that the user is about to engage in or is currently engaged in). In an embodiment, the event module 110 is arranged to access an electronic schedule of the user and identify an appointment on the electronic schedule as the event. In an embodiment, the electronic schedule may be retrieved from local storage (e.g., storage device 118). In an embodiment, the electronic schedule is an electronic calendar stored on the mobile device 102. In another embodiment, the electronic schedule is retrieved from remote storage (e.g., cloud context provider 120). The appointment may be a meeting. The mood determination module 108 may also use a user's calendar context/event to determine his mood (e.g., an anniversary or his child's birthday party may suggest a better mood).

The presentation module 112 is arranged to provide advice to the user regarding the event, the advice based on the received data, the mood, and the event. In an embodiment, to provide advice to the user regarding the event, the presentation module 112 is arranged to provide a recommendation as to whether the user should attend the event. For example, if the mood determination module 108 determines that the user is in a bad mood, then the presentation module 112 may advise the user to reschedule a sales meeting that is on the user's agenda for that day.

In another embodiment, to provide advice to the user regarding the event, the presentation module 112 is arranged to provide a recommendation of an approach the user should take regarding the event. For example, if the mood determination module 112 determines that the user is feeling upset or frustrated, then the presentation module 112 may advise the user to approach a sales call with a certain attitude or take the sales call in a calm, quiet, or soothing environment.

The amount and type of advice may be configured by the user. In an embodiment, the user preference module 114 stores and retrieves the user's preferences for providing advice. In addition, the user may allow the system 100 to share the user's mood with one or more other people in the user's social circles in their social network 122. For example, the user may wish to share their mood with their spouse. In an embodiment, the user preference module 114 is arranged to determine a sharing preference, the sharing preference set by the user and associated with a type of mood. The data sharing module 116 may be arranged to conditionally share the mood with another person when the mood is the type of mood associated with the sharing preference. Moods may be classified into three general moods: “good,” “neutral,” and “bad.” Each of these types may be classified further into subtypes (e.g., categories, sub-categories, etc.). For example, “good” may be further classified into “euphoric,” “happy,” “cheerful,” “excited,” etc. The general “neutral” mood type may be further classified into subtypes of “bored,” “sleepy,” “calm,” “contemplative,” etc. The general “bad” mood type may be further classified into subtypes of “angry,” “exhausted,” “sick,” “cranky,” etc. A user may define a sharing preference for general mood types, subtypes, or actual moods, in various embodiments.

Messages between the data sharing module 116 and the social network 122 may be transmitted using any of a variety of transmission protocols or mechanisms, including but not limited to cellular transmission, Wi-Fi®, or satellite. Messages may be encrypted using a variety of cryptographic mechanisms (e.g., protocols), such as secure sockets layer (SSL), transport layer security (TLS), asymmetrical key encryption such as Pretty Good Privacy (PGP), or IP security (IPSec).

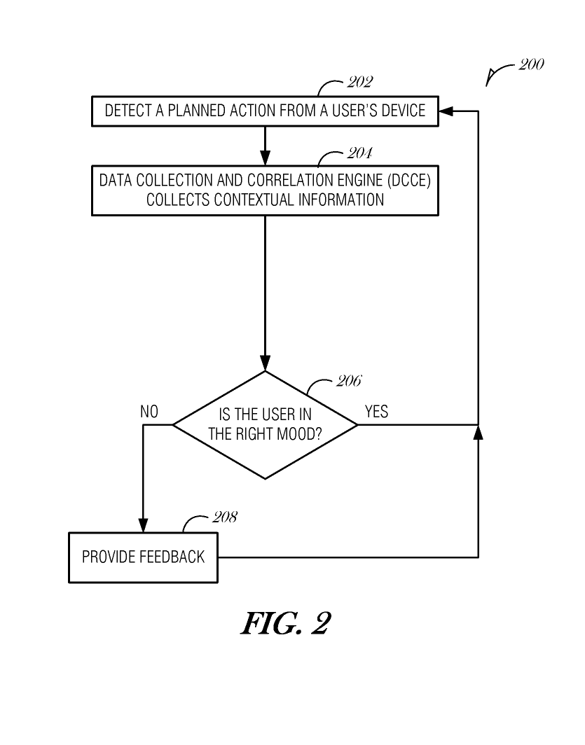

FIG. 2 is a flowchart illustrating a method 200 of detecting a user's mood and using the mood to advise the user, according to an embodiment. At block 202, a planned action is detected at a user's device. For example, the device may access a user's appointment book and determine that the user has a meeting with a customer A at a location X in one hour. At block 204, data representing contextual information is collected by a data collection and correlation engine (DCCE). The data may be collected from various sensors or other sources. Continuing the example, the data may include the user's stress levels, recent activities, the nature of the scheduled meeting, the driving distance to the location X, road conditions on the way, traffic conditions, weather, etc. At decision block 206, it is determined whether the user is in the right mood. The right mood is a subjective, but may be represented with a configurable set (e.g., range) of moods and may be further represented with a scaled value with a lower end of the scale representing a “bad” mood and a higher end of the scale representing a “good” mood. Depending on various contextual, biological, and other information available to the DCCE, the user's mood may be evaluated and rated. If the user's mood meets or exceeds a threshold value toward the “good” mood end of the mood spectrum, then the DCCE may determine that the user is in the “right mood.” If the user is determined as being in the right mood, then no action is taken and monitoring may continue. Alternatively, if the user is determined as not being in the right mood, then one or more feedback actions may be conducted. Feedback may be in the form of audible, textual, tactile, or other forms of communication. The feedback may be an alert, such as via a graphical user interface, informing the user about their perceived stress level, potential challenges or consequences of taking the scheduled planned action under the user's current mood. The feedback may include an alternative action, such as calling the customer A, rescheduling the meeting, or sending another person to handle the transaction. The feedback may also include sending an alert or other information to one or more people in the user's social circle. For example, if the user decides to forego the meeting, then an alert may be generated to the user's coworkers indicating this and allowing one or more coworkers to handle the situation on the user's behalf. It is understood that this merely one example and that other types of user activities may be sensed or tracked, other types of feedback may be used, and that the determination of the “right” mood may be dependent on more or fewer variables.

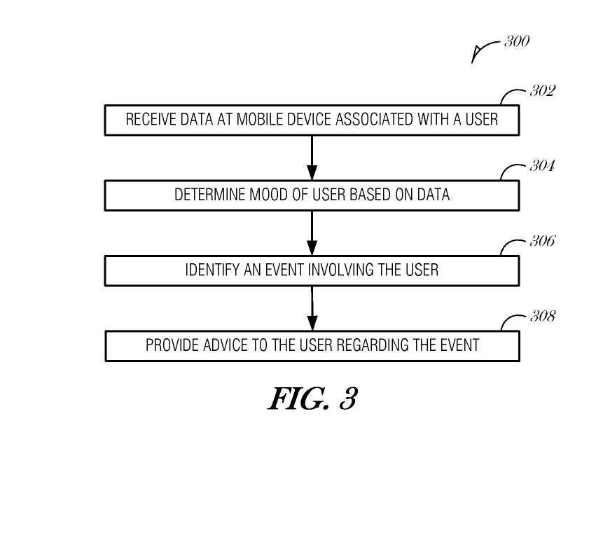

FIG. 3 is a flowchart illustrating a method 300 of using a user's mood and context to advise the user, according to an embodiment. At block 302, data is received at mobile device associated with a user. In an embodiment, the data is received from a device worn by the user.

In an embodiment, the data comprises physiological data. In such an embodiment, determining the mood of the user comprises analyzing the physiological data according to a model and based on the analysis, classifying the mood.

In an embodiment, the data comprises location data. In such an embodiment, determining the mood of the user comprises identifying a location based on the location data and determining a correlation between the location and the mood to classify the mood.

At block 304, a mood of the user is determined based on the data.

At block 306, an event involving the user is identified. In an embodiment, identifying the event is performed by accessing an electronic schedule of the user and identifying an appointment on the electronic schedule as the event. In a further embodiment, the electronic schedule is an electronic calendar stored on the mobile device. In a further embodiment, the appointment is a meeting.

At block 308, advice is provided to the user regarding the event, where the advice is based on the received data, the mood, and the event. In an embodiment, providing advice to the user regarding the event comprises providing a recommendation as to whether the user should attend the event. In another embodiment, providing advice to the user regarding the event comprises providing a recommendation of an approach the user should take regarding the event.

In an embodiment, the method 300 comprises determining a sharing preference, where the sharing preference set by the user and associated with a type of mood and conditionally sharing the mood with another person when the mood is the type of mood associated with the sharing preference.

### Hardware Platform

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time.

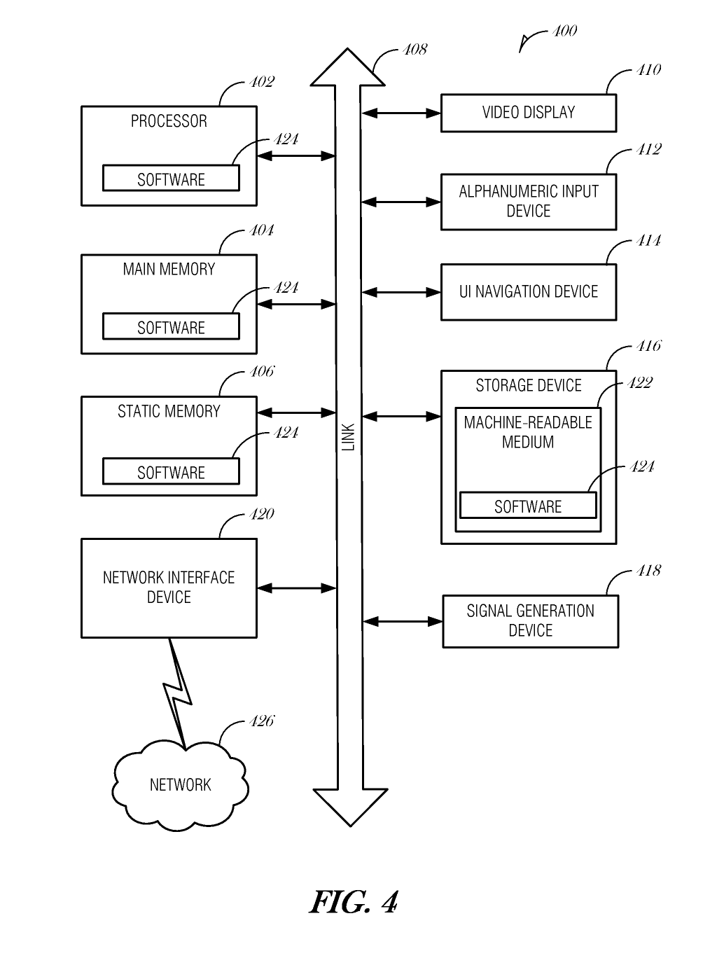

FIG. 4 is a block diagram illustrating a machine in the example form of a computer system 400, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, personal computer (PC), a tablet PC, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 400 includes at least one processor 402 (e.g., a central processing unit (CPU), a graphics processing unit (GPU) or both, processor cores, compute nodes, etc.), a main memory 404 and a static memory 406, which communicate with each other via a link 408 (e.g., bus). The computer system 400 may further include a video display unit 410, an alphanumeric input device 412 (e.g., a keyboard), and a user interface (UI) navigation device 414 (e.g., a mouse). In one embodiment, the video display unit 410, input device 412 and UI navigation device 414 are incorporated into a touch screen display. The computer system 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, or other sensor.

The storage device 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404, static memory 406, and/or within the processor 402 during execution thereof by the computer system 400, with the main memory 404, static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database, and/or associated caches and servers) that store the one or more instructions 424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3 G, and 4 G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples:

Example 1 includes subject matter (such as a device, apparatus, or machine comprising a system to determine and use mood to provide advice, comprising: a data module arranged to receive data; a mood determination module arranged to determine a mood of a user of the device based on the data; an event module arranged to identify an event involving the user; and a presentation module arranged to provide advice to the user regarding the event, the advice based on the received data, the mood, and the event.

In Example 2, the subject matter of Example 1 may optionally include, wherein to receive data at the device, the data module is arranged to receive data from a device worn by the user.

In Example 3 the subject matter of any one or more of Examples 1 to 2 may optionally include, wherein the data comprises physiological data and wherein to determine the mood of the user, the mood determination module is arranged to: analyze the physiological data according to a model; and classify the mood based on the analysis.

In Example 4 the subject matter of any one or more of Examples 1 to 3 may optionally include, wherein the data comprises location data and wherein to determine the mood of the user, the mood determination module is arranged to: identify a location based on the location data; and determine a correlation between the location and the mood to classify the mood.

In Example 5 the subject matter of any one or more of Examples 1 to 4 may optionally include, wherein to identify the event, the event module is arranged to: access an electronic schedule of the user; and identify an appointment on the electronic schedule as the event.

In Example 6 the subject matter of any one or more of Examples 1 to 5 may optionally include, wherein the electronic schedule is an electronic calendar stored on the device.

In Example 7 the subject matter of any one or more of Examples 1 to 6 may optionally include, wherein the appointment is a meeting.

In Example 8 the subject matter of any one or more of Examples 1 to 7 may optionally include, wherein to provide advice to the user regarding the event, the presentation module is arranged to provide a recommendation as to whether the user should attend the event.

In Example 9 the subject matter of any one or more of Examples 1 to 8 may optionally include, wherein to provide advice to the user regarding the event, the presentation module is arranged to provide a recommendation of an approach the user should take regarding the event.

In Example 10 the subject matter of any one or more of Examples 1 to 9 may optionally include, a user preference module arranged to determine a sharing preference, the sharing preference set by the user and associated with a type of mood; and a data sharing module arranged to conditionally share the mood with another person when the mood is the type of mood associated with the sharing preference.

Example 11 includes or may optionally be combined with the subject matter of any one of Examples 1-10 to include subject matter for using a user's mood and context to advise a user (such as a method, means for performing acts, machine readable medium including instructions that when performed by a machine cause the machine to performs acts, or an apparatus configured to perform) comprising receiving data at a mobile device, the mobile device associated with the user; determining a mood of the user based on the data; identifying an event involving the user; and providing advice to the user regarding the event, the advice based on the received data, the mood, and the event.

In Example 12, the subject matter of Example 11 may optionally include, wherein receiving data comprises: receiving data from a device worn by the user.

In Example 13 the subject matter of any one or more of Examples 11 to 12 may optionally include, wherein the data comprises physiological data and wherein determining the mood of the user comprises: analyzing the physiological data according to a model; and classifying the mood based on the analysis.

In Example 14 the subject matter of any one or more of Examples 11 to 13 may optionally include, wherein the data comprises location data and wherein determining the mood of the user comprises: identifying a location based on the location data; and determining a correlation between the location and the mood to classify the mood.

In Example 15 the subject matter of any one or more of Examples 11 to 14 may optionally include, wherein identifying the event comprises: accessing an electronic schedule of the user; and identifying an appointment on the electronic schedule as the event.

In Example 16 the subject matter of any one or more of Examples 11 to 15 may optionally include, wherein the electronic schedule is an electronic calendar stored on the mobile device.

In Example 17 the subject matter of any one or more of Examples 11 to 16 may optionally include, wherein the appointment is a meeting.

In Example 18 the subject matter of any one or more of Examples 11 to 17 may optionally include, wherein providing advice to the user regarding the event comprises providing a recommendation as to whether the user should attend the event.

In Example 19 the subject matter of any one or more of Examples 11 to 18 may optionally include, wherein providing advice to the user regarding the event comprises providing a recommendation of an approach the user should take regarding the event.

In Example 20 the subject matter of any one or more of Examples 11 to 19 may optionally include, determining a sharing preference, the sharing preference set by the user and associated with a type of mood; and conditionally sharing the mood with another person when the mood is the type of mood associated with the sharing preference.

Example 21 includes or may optionally be combined with the subject matter of any one of Examples 1-20 to include a machine-readable medium including instructions for using mood to provide advice, which when executed by a machine, cause the machine to perform operations of any one of the examples 1-20.

Example 22 includes or may optionally be combined with the subject matter of any one of Examples 1-20 to include an apparatus comprising means for performing any of the examples 1-20.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described.

However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1-22. (canceled)

23. A device to determine and use mood to provide advice, the device comprising:
a data module arranged to receive data;
a mood determination module arranged to determine a mood of a user of the device based on the data;
an event module arranged to identify an event involving the user; and
a presentation module arranged to provide advice to the user regarding the event, the advice based on the received data, the mood, and the event.

24. The device of claim 23, wherein to receive data at the device, the data module is arranged to receive data from a device worn by the user.

25. The device of claim 23, wherein the data comprises physiological data and wherein to determine the mood of the user, the mood determination module is arranged to:
analyze the physiological data according to a model; and
classify the mood based on the analysis.

26. The device of claim 23, wherein the data comprises location data and wherein to determine the mood of the user, the mood determination module is arranged to:
identify a location based on the location data; and
determine a correlation between the location and the mood to classify the mood.

27. The device of claim 23, wherein to identify the event, the event module is arranged to:
access an electronic schedule of the user; and
identify an appointment on the electronic schedule as the event.

28. The device of claim 27, wherein the electronic schedule is an electronic calendar stored on the device.

29. The device of claim 27, wherein the appointment is a meeting.

30. The device of claim 23, wherein to provide advice to the user regarding the event, the presentation module is arranged to provide a recommendation as to whether the user should attend the event.

31. The device of claim 23, wherein to provide advice to the user regarding the event, the presentation module is arranged to provide a recommendation of an approach the user should take regarding the event.

32. The device of claim 23, comprising:
a user preference module arranged to determine a sharing preference, the sharing preference set by the user and associated with a type of mood; and
a data sharing module arranged to conditionally share the mood with another person when the mood is the type of mood associated with the sharing preference.

33. A method for using a user's mood and context to advise a user, the method comprising:
receiving data at a mobile device, the mobile device associated with the user;
determining a mood of the user based on the data;
identifying an event involving the user; and
providing advice to the user regarding the event, the advice based on the received data, the mood, and the event.

34. The method of claim 33, wherein receiving data comprises:
receiving data from a device worn by the user.

35. The method of claim 33, wherein the data comprises physiological data and wherein determining the mood of the user comprises:
analyzing the physiological data according to a model; and
classifying the mood based on the analysis.

36. The method of claim 33, wherein the data comprises location data and wherein determining the mood of the user comprises:
identifying a location based on the location data; and
determining a correlation between the location and the mood to classify the mood.

37. The method of claim 33, wherein identifying the event comprises:
accessing an electronic schedule of the user; and
identifying an appointment on the electronic schedule as the event.

38. The method of claim 37, wherein the electronic schedule is an electronic calendar stored on the mobile device.

39. The method of claim 37, wherein the appointment is a meeting.

40. The method of claim 33, wherein providing advice to the user regarding the event comprises providing a recommendation as to whether the user should attend the event.

41. The method of claim 33, wherein providing advice to the user regarding the event comprises providing a recommendation of an approach the user should take regarding the event.

42. The method of claim 33, comprising:
determining a sharing preference, the sharing preference set by the user and associated with a type of mood; and
conditionally sharing the mood with another person when the mood is the type of mood associated with the sharing preference.

43. A machine-readable medium including instructions for using mood to provide advice, which when executed by a machine, cause the machine to:
receive data at a mobile device, the mobile device associated with the user;
determine a mood of the user based on the data;
identify an event involving the user; and
provide advice to the user regarding the event, the advice based on the received data, the mood, and the event.
